(19) United States
(12) Patent Application Publication
(10) Pub. No.: US 2017/0275134 A1
(43) Pub. Date: Sep. 28, 2017

(54) ELEVATOR SECURITY AND CONTROL SYSTEM BASED ON PASSENGER MOVEMENT

(71) Applicant: OTIS ELEVATOR COMPANY, Farmington, CT (US)

(72) Inventors: Meghan Q. Toner, West Hartford, CT (US); Stephen K. Richmond, Hartford, CT (US)

(21) Appl. No.: 15/529,334

(22) PCT Filed: Nov. 20, 2015
(86) PCT No.: PCT/US2015/061794

§ 371 Date: May 24, 2017

Related U.S. Application Data
(60) Provisional application No. 62/084,693, filed on Nov. 26, 2014.

(51) Int. Cl. B66B 5/00; B66B 5/02; B66B 1/28

(52) U.S. Cl. CPC B66B 5/0012; B66B 1/28; B66B 5/025

(57) ABSTRACT

An elevator security and control system for monitoring at least one of an elevator occupancy area and a landing area includes an elevator car and a passenger position sensor. The passenger position sensor monitors at least one of the occupancy area inside the elevator car and the landing area proximate to a passenger waiting area, and detects movement of at least one passenger located at one of the occupancy area and the landing area. The elevator security and control system further includes an electronic control module that detects at least one body part of the at least one passenger and controls operation of the elevator car based on at least one of a position and a movement of the at least one body part.

### TECHNICAL FIELD

This present disclosure relates generally to elevator control systems, and more particularly, to an elevator security and control system.

### BACKGROUND

Conventional elevator systems include cameras that monitor the presence of passengers in an elevator car. However, traditional sensing technologies are typically limited to detecting passenger boarding/deboarding and elevator car occupancy. Traditional elevator operation, however, is not controlled according to the behavior of one or more passengers.

During operation of the elevator, emergency events, unauthorized actions by passengers, and/or confrontations between two or more passenger may occur which require security and/or emergency personnel to be alerted. Conventional elevator emergency systems, however, require that security staff manually monitor video feeds to detect unauthorized actions or emergency events. Moreover, once an unauthorized actions or emergency events, the security personnel must manually intervene by locating the elevator car during ride operation, manually disabling the elevator car from service and/or manually contacting emergency personnel. The conventional means for resolving unauthorized actions and/or emergency events is therefore time-consuming and inefficient.

### SUMMARY

According to embodiment, an elevator security and control system for monitoring at least one of an elevator occupancy area and a landing area includes an elevator car and a passenger position sensor. The passenger position sensor monitors at least one of the occupancy area inside the elevator car and the landing area proximate to a passenger waiting area, and detects movement of at least one passenger located at one of the occupancy area and the landing area. The elevator security and control system further includes an electronic control module that detects at least one body part of the at least one passenger and controls operation of the elevator car based on at least one of a position and a movement of the at least one body part.

In addition to one or more of the features described above, or as an alternative, further embodiments include one or more of the following:

a feature, wherein the electronic control module determines a fixed area of interest located in the occupancy area and controls the elevator car based on a position of the at least one body part with respect to the fixed area of interest;

a feature, wherein the electronic control module determines a time period at which the at least one body part is positioned within the fixed area of interest and determines a security breach when the time period exceeds a time threshold;

a feature, wherein the electronic control module overrides operation of the elevator car in response to determining the security breach;

a feature, wherein the electronic control module distinguishes a first passenger located in at least one of the occupancy area and the landing area from a second passenger located in proximity to the first passenger;

a feature, wherein the electronic control module determines a security breach based on a position of a first body part of the first passenger with respect to a second body part of the second passenger;

a feature, wherein the electronic control module overrides operation of the elevator car in response to the security breach lasting greater than a time period threshold; and

a feature, wherein the passenger position sensor includes a line of motion sensing input device that outputs data indicating a skeletal image of the at least one passenger, and wherein the electronic control module compares motion of the skeletal image to at least one anatomical model stored in memory to determine the movement of the at least one passenger.

According to another embodiment, a method of controlling an elevator system includes monitoring at least one of an occupancy area inside an elevator car and a landing area proximate to a passenger waiting area. The method further includes detecting movement of at least one passenger located in at least one of the occupancy area and the landing area. The method further includes determining at least one body part of the at least one passenger and controlling operation of the elevator car based on at least one of a position and a movement of the at least one body part.

In addition to one or more of the features described above, or as an alternative, further embodiments include one or more of the following:

determining a fixed area of interest located in the occupancy area and controls the elevator car based on a position of the at least one body part with respect to the fixed area of interest;

determining a time period at which the at least one body part is positioned within the fixed area of interest and determines a security breach when the time period exceeds a time threshold;

overriding operation of the elevator car in response to determining the security breach;

distinguishing a first passenger located in the occupancy area from a second passenger located in the occupancy area;

determining a security breach based on a position of a first body part of the first passenger with respect to a second body part of the second passenger; and

overriding operation of the elevator car in response to the security breach lasting greater than a time period threshold.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating an elevator security and control system according to a non-limiting embodiment;

FIGS. 2A-2E illustrate images captured by an image sensor included and in turn analyzed by an electronic elevator control module included in an elevator security and control system according to a non-limiting embodiment; and

FIG. 3 is a flow diagram illustrating a method of controlling an elevator system according to a non-limiting embodiment.

### DETAILED DESCRIPTION OF THE INVENTION

Various non-limiting embodiments of the invention utilize motion tracking sensors such as, for example, video, radar, infrared, etc., to detect movements of one or more passengers. An electronic elevator control module can be programed with software, anatomical models and/or motion algorithms that distinguish normal movements from abnormal movements and may determine that one or more security/emergency actions are necessary based on the abnormal movements. The security/emergency actions include, but are not limited to, alerting security/emergency personnel, cancelling an elevator call in order not to put passengers in an enclosed/unmonitored space for their safety and the safety of passengers standing by, generating an acoustic alert to notify the passengers of a security issue, and/or automatically overriding current elevator operations. An elevator car over-ride can include, for example, returning the elevator car directly to the lobby or removing the elevator car from service by stopping at a next available floor or specific floor, and/or controlling operation of the elevator doors until the security/emergency event is resolved. In this manner, alerted security/emergency personnel can conveniently and quickly intervene and/or intercept one or more suspect passengers.

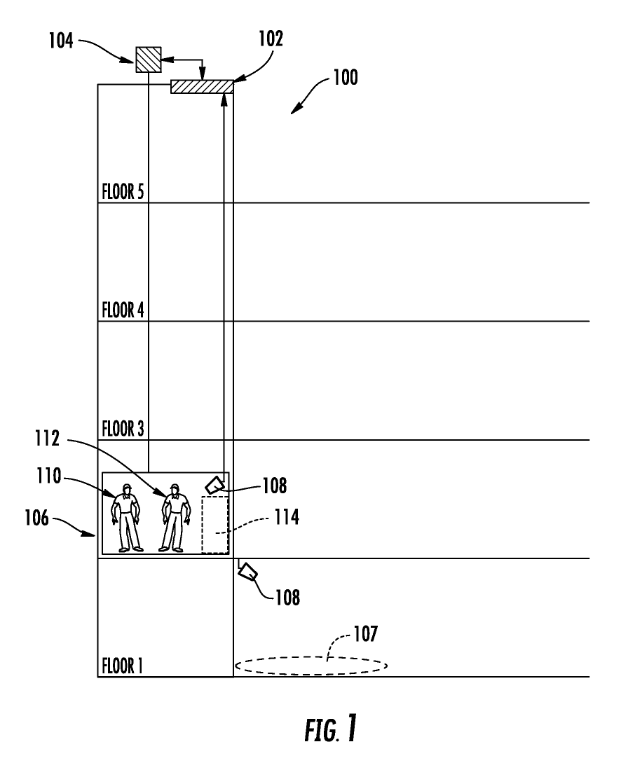

Referring to FIG. 1, an elevator security and control system 100 is illustrated according to a non-limiting embodiment. The elevator security and control system 100 includes an electronic elevator control module 102, and an elevator car driving assembly 104. The elevator car driving assembly 104 includes a machine that imparts movement to elevator car 106 as understood by one of ordinary skill in the art. The elevator control module 102 includes an electronic microcontroller, for example, configured to output one or more electrical signals capable of controlling the operation of the elevator car driving assembly 104 and the elevator car 106 as understood by one of ordinary skill in the art.

The elevator security and control system 100 further includes one or more elevator car passenger sensors 108 in electrical communication with the elevator control module 102. Although a single elevator car passenger sensor 108 is shown, it is appreciated that a plurality of elevator car passenger sensor 108 may be utilized. The elevator car passenger sensor 108 is configured as a video camera coupled with a line of motion sensing input device, for example, that outputs an electrical signal to the elevator control module 102. In turn, the elevator control module 102 can process the output of the image sensor 108 to generate an image of the internal occupancy area of the elevator car 106 and any passengers 110-112 located in the occupancy area and/or an image of the area 107 proximate to the elevator car, e.g., the area where passengers are standing by in anticipation to board. According to an embodiment, the elevator control module 102 receives the output from the elevator car passenger sensor 108, and generates an image such as a three dimensional (3-D) image, for example, which can be tracked. For example, the elevator control module 102 can interpret specific gestures, movements and motions of one or more passengers. In addition, the elevator control module 102 can interpret the motion of a first passenger's body parts (e.g., hands, arms, legs, etc.) with respect to a particular region of the occupancy area and/or the body parts of other passengers 110-112 residing in the occupancy area, as discussed in greater detail below.

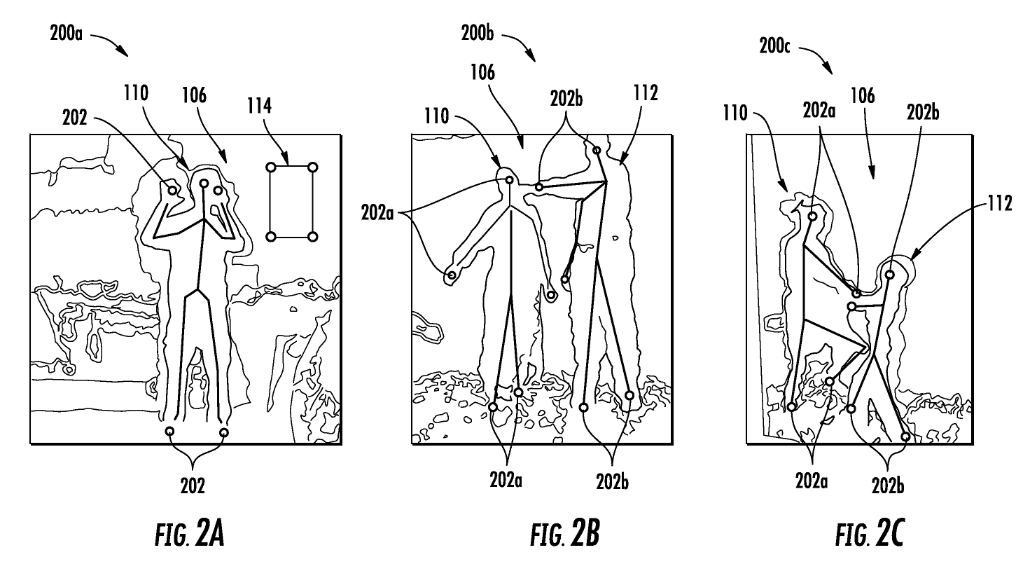

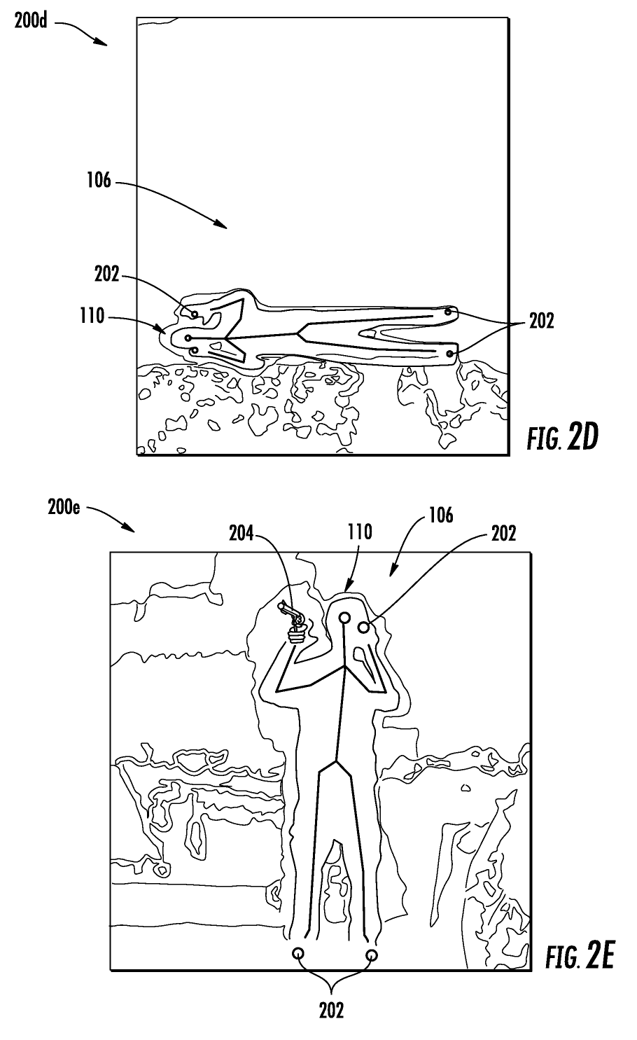

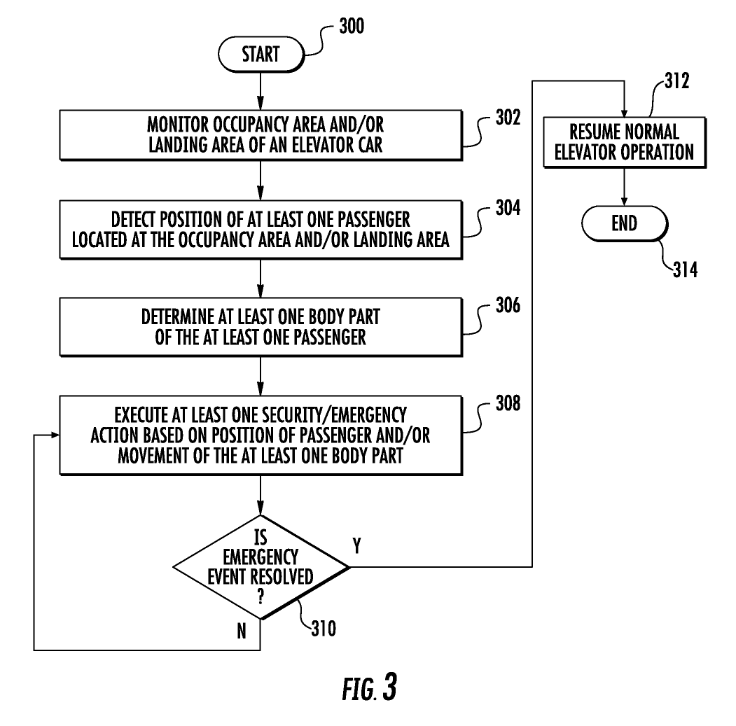

Turning to FIG. 2A, a 3-D image of an occupancy area within an elevator car 106 is illustrated according to a non-limiting embodiment. The 3-D image 200a is generated by the electronic elevator control module 102 based on an output of a line of motion sensing input device 108 installed within the elevator car 106. Although the occupancy area within the elevator car 106 is described going forward, it is appreciated that the 3-D image 200a can be of an area 107 located externally from the elevator car 106 without departing from the scope of the invention. The area located externally from the elevator car 106 can include, for example, a landing area 107 proximate an area where potential passengers standby waiting for the elevator car 106 to arrive at the elevator landing. The 3-D image 200a shows a first passenger 110 reconstructed as a moveable skeletal image, and a fixed area of interest 114. The skeletal image (e.g., 3-D image) of the first passenger 110 indicates one or more individual body parts 202 including, but not limited to, hands, arms, legs, feet, knees, elbows, and a head.

According to a non-limiting embodiment, the elevator control module 102 is configured to track and detect the motion and/or position of the individual body parts 202 with respect to the fixed area of interest 114 such as, for example, a secured area 114 to be accessed by authorized personnel only. Various depth sensors exist that provide full-body 3D motion capture, facial recognition as understood by one of ordinary skill in the art. For example, the depth sensor may include an infrared laser projector combined with a monochrome CMOS sensor, which captures video data in 3D under any ambient light conditions. The depth sensors may also be configured to adjust the sensing range of and automatically calibrate the sensor based on a person's physical environment. If a passenger's body part 202 (e.g., hand) enters the fixed area of interest 114, the electronic elevator control module 102 determines a security breach and executes one or more security measures. The security measures include, for example, generating a vocal alert in the occupancy area informing the passenger 110 that the current actions constitute a security breach and that continuing such action will result in notification of security personnel. When the passenger 110 removes the corresponding body part 202 from the area of interest 114 within the time threshold, the security breach alert is removed and the control module 102 operates the elevator car 106 as normal. When, however, the elevator control module 102 determines that the body part 202 has not been removed from the area of interest 114 within the time threshold following the vocal alert, the elevator control module 102 can take additional security measures including, for example, ceasing operation of the elevator car 106, notifying security personnel of the security breach, and moving the elevator car 106 to the lobby such that security personnel can conveniently confront the passenger 110.

Turning now to FIGS. 2B-2C, 3-D images 200b-200c show first and second passengers 110-112 located at occupancy area within an elevator car 106. According to a non-limiting embodiment, the elevator control module 102 is configured to track and detect the motion of the first passenger's 110 individual body parts 202 with respect to the motion of the second passenger's 112 individual body parts 202. The detection of one or more body parts 202a-202b include tracking the speed and movement of the body parts 202 to distinguish normal movements (e.g., normal standing, friendly conversation and interactions, and/or normal crowded car conditions) from abnormal movements (e.g., physical contact, fighting, pushing, aggressive movements, etc.). For example, the speed, motion and direction of a passenger's arm can be compared to one or more anatomical models (e.g., skeletal motion models) and/or algorithms (e.g., structure light algorithm. mean-shift algorithm, etc.) stored in the elevator control module 102 to determine whether a passenger's arm is moving in a punching motion. Various other abnormal acts such as, for example, jumping, climbing, rapid arm/leg movements, etc., can be determined based on a comparison of one or more body parts 202 with respect the one or more anatomical models (e.g., skeletal motion models) and/or algorithms (e.g., structure light algorithm. mean-shift algorithm, etc.).

When one or more passengers are located at area located externally from the elevator car 106, i.e., at the elevator landing area 107, the elevator control module 102 can still detect the movement and/or position of one or more passengers' body parts 202 as discussed above. When an emergency event and/or security event is detected in this case, the elevator control module 102 can execute various emergency and or security measures including, but not limited to, generating a vocal alert in the occupancy area informing the passengers 110-112 that the current actions constitute a security breach and that continuing such action will result in notification of security personnel, ceasing operation of the elevator car 106, and automatically notifying security/emergency personnel of the security/emergency event,

According to a non-limiting embodiment, the elevator control module 102 is configured to track and detect the motion of one or more individual body parts 202a of a first passenger 110 with respect to the one or more body parts 202b of a second passenger 112. Turning to FIG. 2B, for example, the electronic elevator control module 102 detects that the body part 202b (i.e., hand/fist) of a second passenger 112 is in close proximity or contacts an body part 202a (i.e., head) of a first passenger 110. Accordingly, the elevator control module 102 determines a security breach exists and executes one or more security measures. The security measures include, for example, generating a vocal alert in the occupancy area informing the passengers 110-112 that the current actions constitute a security breach and that continuing such action will result in notification of security personnel. The elevator control module 102 can take additional security measures including, for example, ceasing operation of the elevator car 106, notifying security personnel of the security breach, and moving the elevator car 106 to a specific floor, e.g., the lobby, such that security personnel can conveniently confront one or more of the passengers 110-112.

Similarly, FIG. 2C illustrates a scenario where a physical altercation occurs between a first passenger 110 and a second passenger 112. According to a non-limiting embodiment, the electronic elevator control module 102 determines an apparent physical struggle between a first passenger 110 and a second passenger 112 based on the proximity and movements of the first passenger's body parts 202a and the second passengers body parts 202b. Accordingly, the elevator control module 102 determines a security breach exists and executes one or more security measures. The security measures include, for example, generating a vocal alert in the occupancy area informing the passengers 110-112 that the current actions constitute a security breach and that continuing such actions will result in notification of security personnel.

According to another embodiment illustrated in FIG. 2D, the electronic elevator control module 102 analyzes a 3-D image 200d and determines an emergency event in response to detecting a prone position of a first passenger 110 and determining the lack of movement among the first passenger's body parts 202. In response to determining the emergency event, the elevator control module 102 executes one or more emergency measures. The emergency measures include, for example, automatically contacting emergency personnel (e.g., automatically dialing 911), automatically delivering the elevator car 106 to the lobby and opening the doors, and/or removing the elevator car 106 containing the first passenger 110 from service. Although FIG. 2D shows the prone position of only the first passenger, it is appreciated that the elevator control module 102 may also determine the prone position and emergency event of the first passenger 110 following an altercation with one or more second passengers within the elevator car 106.

Turning to FIG. 2E, another embodiment is illustrated where the electronic elevator control module 102 analyzes a 3-D image 200e and determines that a first passenger 110 possess a weapon 204 such as, for example, a gun 204. In response to detecting the weapon 204, the elevator control module 102 determines a security breach exists and executes one or more security measures. The security measures include, for example, generating a vocal alert in the occupancy area informing the passengers 110-112 that the current actions constitute a security breach and that continuing such actions will result in notification of security personnel. Other security measures include, but are not limited to, ceasing operation of the elevator car 106, automatically notifying security personnel of the security breach (e.g., calling 911), and moving the elevator car 106 to a specific floor, e.g., the lobby, such that security personnel can conveniently confront one or more of the passengers 110-112, and/or removing the elevator from service such that passengers standing by for the elevator do not encounter the first passenger 110 possessing the weapon 204.

According to a non-limiting embodiment, when the passengers 110-112 stop the physical acts within the time threshold, the security breach alert is removed and the control module 102 operates the elevator car 106 as normal. When, however, the elevator control module 102 determines that the physical altercation has not stopped within the time threshold following the vocal alert, the elevator control module 102 can take additional security measures including, for example, ceasing operation of the elevator car 106, notifying security personnel of the security breach, and moving the elevator car 106 to the lobby such that security personnel can conveniently confront one or more of the passengers 110-112 as described above. In this manner, friendly acts or boisterous play can be distinguished from aggressive movements intended to inflict physical harm. As described above, the elevator control module 102 may also determine the prone position and emergency event of the first passenger 110 if the physical alteration ends with one or more passengers 110-112 motionless on the floor.

Turning now to FIG. 3, a flow diagram illustrates a method of controlling an elevator system according to a non-limiting embodiment. The method begins at operation 300 and at operation 302 an occupancy area of an elevator car and/or a landing area is monitored. At operation 304, the movement of at least one passenger located at the occupancy area and/or landing area is detected, and at least one body part of the at least one passenger is determined at operation 306. The movement and/or position of at least one passenger and a passenger's body parts can be determined using various cameras and depth sensors as described above. The movement can include a passenger's movement of a body part in proximity to an unauthorized area of the elevator, for example. According to another embodiment, the movement can include a physical confrontation between two or more passengers located in the occupancy area or the landing area. An unconscious or prone passenger located on the floor/ground can also be determined as discussed in detail above.

At operation 308, one or more emergency/security actions are executed based on the movement and/or position of one or more body parts of a passenger. For example, if a prone position of a first passenger is detected and the lack of movement among the first passenger's body is determined, the emergency/security event can include automatically contacting emergency personnel (e.g., automatically dialing 911), automatically delivering the elevator car to the lobby and opening the doors, and/or removing the elevator car containing the first passenger from service the method ends at operation. According to another embodiment, a physical altercation occurs between a first passenger and a second passenger. According to a non-limiting embodiment, a physical struggle between two or more passengers can be determined based on the proximity and movements of the passengers' body parts. Accordingly, one or more emergency/security measures can be executed in response to determining the altercation. The emergency/security measures include, but are not limited to, alerting security/emergency personnel, cancelling an elevator call, generating an acoustic alert to notify the passengers of a security issue, returning the elevator car directly to the lobby or removing the elevator car from service by stopping at a next available floor or specific floor, and controlling operation of the elevator doors until the security/emergency event is resolved. At operation 310, the system determines whether the emergency/security event has been resolved. If the emergency/security event has not been resolved, then the emergency/security action continues at operation 308. Otherwise, the emergency/security action is stopped such that the elevator system returns to normal operation at operation 312, and the method ends at operation 314.

As used herein, the term “module” refers to a hardware module including an Application Specific Integrated Circuit (ASIC), an electronic circuit, a processor (shared, dedicated, or group) and memory that execute one or more software or firmware programs, a combinational logic circuit, and/or other suitable components that provide the described functionality.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator security and control system for monitoring at least one of an elevator occupancy area and a landing area, comprising:
an elevator car;
a passenger position sensor configured to monitor at least one of the occupancy area inside the elevator car and the landing area proximate to a passenger waiting area, and to detect movement of at least one passenger located in at least one of the occupancy area and the landing area; and
an electronic control module in communication with the passenger position sensor, the electronic control module configured to detect at least one body part of the at least one passenger and to execute at least one security/emergency action based on at least one of a position and a movement of the at least one body part.

2. The elevator security and control system of claim 1, wherein the electronic control module determines a fixed area of interest located in at least one of an occupancy area and a landing area, and controls the elevator car based on a position of the at least one body part with respect to the fixed area of interest.

3. The elevator security and control system of claim 2, wherein the electronic control module determines a time period at which the at least one body part is positioned within the fixed area of interest and determines a security breach when the time period exceeds a time threshold.

4. The elevator security and control system according to claim 3, wherein the electronic control module overrides operation of the elevator car in response to determining the security breach, and wherein the at least one security/emergency action includes alerting security/emergency personnel, cancelling an elevator call, generating an acoustic alert to notify the passengers of a security issue, returning the elevator car directly to the lobby or removing the elevator car from service by stopping at a next available floor or specific floor, and controlling operation of the elevator doors until the security/emergency event is resolved.

5. The elevator security and control system of claim 1, wherein the electronic control module distinguishes a first passenger located in at least one of the occupancy area and the landing area from a second passenger located in proximity to the first passenger.

6. The elevator security and control system of claim 5, wherein the electronic control module determines a security breach based on a position of a first body part of the first passenger with respect to a second body part of the second passenger.

7. The elevator security and control system of claim 6, wherein the electronic control module overrides operation of the elevator car in response to the security breach lasting greater than a time period threshold.

8. The elevator security and control system of claim 1, wherein the passenger position sensor includes a line of motion sensing input device that outputs data indicating a skeletal image of the at least one passenger, and wherein the electronic control module compares motion of the skeletal image to at least one anatomical model stored in memory to determine the movement of the at least one passenger.

9. A method of controlling an elevator system, the method comprising:
monitoring at least one of an occupancy area inside an elevator car and a landing area proximate to a passenger waiting area, and detecting movement of at least one passenger located in at least one of the occupancy area and the landing area; and
determining at least one body part of the at least one passenger and executing at least one security/emergency action based on at least one of a position and a movement of the at least one body part.

10. The method of claim 9, further comprising determining a fixed area of interest located in the occupancy area and controls the elevator car based on a position of the at least one body part with respect to the fixed area of interest.

11. The method of claim 10, further comprising determining a time period at which the at least one body part is positioned within the fixed area of interest and determines a security breach when the time period exceeds a time threshold.

12. The method according to claim 11, further comprising overriding operation of the elevator car in response to determining the security breach, and wherein the at least one security/emergency action includes alerting security/emergency personnel, cancelling an elevator call, generating an acoustic alert to notify the passengers of a security issue, returning the elevator car directly to the lobby or removing the elevator car from service by stopping at a next available floor or specific floor, and controlling operation of the elevator doors until the security/emergency event is resolved.

13. The method of claim 9, further comprising distinguishing a first passenger located in at least one of the occupancy area and the landing area from a second passenger located in the occupancy area.

14. The method of claim 13, further comprising determining a security breach based on a position of a first body part of the first passenger with respect to a second body part of the second passenger.

15. The method of claim 14, further comprising overriding operation of the elevator car in response to the security breach lasting greater than a time period threshold.
